(19) United States
(12) Patent Application Publication
(10) Pub. No.: US 2017/0249538 A1
(43) Pub. Date: Aug. 31, 2017

(54) PRINTER, PRINTING METHOD, AND NON-TRANSITORY COMPUTER READABLE MEDIUM

(71) Applicant: FUJI XEROX CO., LTD., Tokyo (JP)

(72) Inventors: Yuta NAKAYAMA, Kanagawa (JP); Noriyuki SUZUMURA, Kanagawa (JP); Kazuya TAKAHASHI, Kanagawa (JP); Shinichi TAKANO, Kanagawa (JP); Kazutoshi KONDO, Kanagawa (JP); Daichi TAKAHASHI, Kanagawa (JP); Hosana KIMURA, Kanagawa (JP); Chiemi MIYATA, Kanagawa (JP)

(73) Assignee: FUJI XEROX CO., LTD., Tokyo (JP)

(21) Appl. No.: 15/217,841

(22) Filed: Jul. 22, 2016

(30) Foreign Application Priority Data
Feb. 26, 2016 (JP) 2016-035838

(51) Int. Cl. G06K 15/00; G06K 15/02

(52) U.S. Cl. CPC G06K 15/404; G06K 15/1809; G06K 15/1813; G06K 2215/0011

(57) ABSTRACT

A printer includes a receiver, a detector, and a sort controller. The receiver receives print data described in a page description language. The detector detects a predetermined specific command from the print data received by the receiver. If the detector detects the specific command, the sort controller performs control to sort a printout of a print data portion after the detected specific command from a printout of a print data portion before the detected specific command.

### CROSS-REFERENCE TO RELATED APPLICATIONS

This application is based on and claims priority under 35 USC 119 from Japanese Patent Application No. 2016-035838 filed Feb. 26, 2016.

### BACKGROUND

(i) Technical Field

The present invention relates to a printer, a printing method, and a non-transitory computer readable medium.

(ii) Related Art

In the case of printing plural copies of a document, if a memory built in a printer has a sufficiently large capacity, a printer driver of a client apparatus (for example, a personal computer) may transmit print data of the document and information representing the number of copies to the printer. The printer holds the received print data in the built-in memory and repeatedly performs a process on the print data the same number of times as the number of copies, so as to print the copies of the document. If the amount of print data of the document is larger than the capacity of the built-in memory of the printer, this method is not employed. In this case, the printer driver repeatedly transmits the print data to the printer the same number of times as the number of copies, so as to print the copies of the document.

Many printers have a function of sorting a printout in units of copies or jobs. An example of a widely used sorting function is a function of performing sorting by shifting a paper output tray right and left in units of copies or jobs. Also, some of compact printers that do not have a mechanism of shifting a paper output tray have a function of performing sorting in units of copies by changing the orientation of paper for a printout to portrait or landscape in units of copies.

In the case of repeatedly transmitting print data the same number of times as the number of copies from the printer driver to the printer and in the case of sorting a print result in units of copies, it is necessary for the printer to detect a separator of each copy of the print data that is continuously transmitted thereto.

### SUMMARY

According to an aspect of the invention, there is provided a printer including a receiver, a detector, and a sort controller. The receiver receives print data described in a page description language. The detector detects a predetermined specific command from the print data received by the receiver. If the detector detects the specific command, the sort controller performs control to sort a printout of a print data portion after the detected specific command from a printout of a print data portion before the detected specific command.

### BRIEF DESCRIPTION OF THE DRAWINGS

An exemplary embodiment of the present invention will be described in detail based on the following figures, wherein:

FIG. 1 is a diagram illustrating an example of the configurations of apparatuses according to an exemplary embodiment;

FIG. 2 is a diagram illustrating an example of PDL determination information;

FIG. 3 is a diagram illustrating an example of separator determination information;

FIG. 4 is a flowchart illustrating an example of a procedure of determining a PDL type;

FIG. 5 is a flowchart illustrating an example of a procedure of detecting a separator and controlling sorting; and

FIG. 6 is a diagram schematically illustrating an example of print data including data of plural copies.

### DETAILED DESCRIPTION

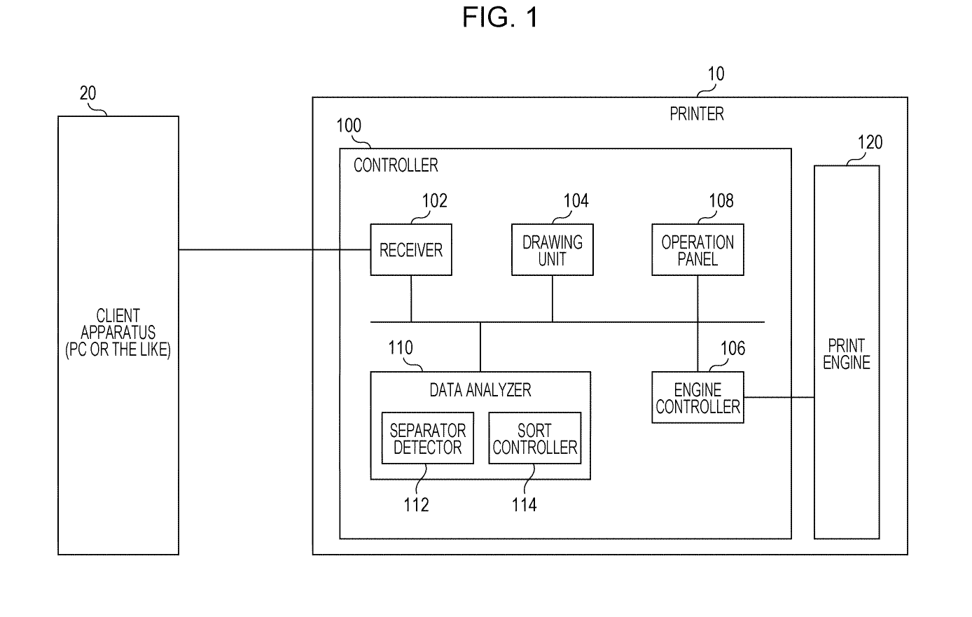

A printer according to an exemplary embodiment of the present invention will be described below with reference to FIG. 1. A printer 10 illustrated below is an apparatus that does not have a sorting function based on a shift operation of a paper output tray and that carries out sorting by changing the orientation of paper to be used in units of copies (or in units of jobs). The orientation of paper may be portrait orientation or landscape orientation of paper on a paper feed tray. The terms “short edge feed (SEF)” and “long edge feed (LEF)” may be used instead of “portrait” and “landscape”, respectively.

The printer 10 according to the exemplary embodiment includes a controller 100 and a print engine 120. The print engine 120 is a mechanical device that prints an image on paper by using a coloring material such as ink or toner. The controller 100 is a control device that controls the print engine 120. The controller 100 receives print data from a client apparatus 20, such as a personal computer (PC), and causes the print engine 120 to print an image represented by the print data.

The controller 100 includes a receiver 102, a drawing unit 104, an engine controller 106, an operation panel 108, and a data analyzer 110.

The receiver 102 receives print data transmitted by the client apparatus 20. The print data is described in a page description language (PDL). A printer driver (not illustrated) of the client apparatus 20 converts a document designated by a user as a target to be printed into print data described in the PDL and transmits the print data to the controller 100. The receiver 102 receives the print data. The printer driver of the client apparatus 20 may have a function of obtaining performance information from the printer 10 at the beginning of printing and, if the performance information satisfies a certain condition (for example, the memory capacity is equal to or smaller than a threshold) and if the number of copies to be printed is plural, repeatedly transmitting the print data to the printer 10 the same number of times as the number of copies. In this case, the receiver 102 repeatedly receives the print data from the client apparatus 20 the same number of times as the number of copies.

The data analyzer 110 analyzes the print data in the PDL received by the receiver 102 (and accompanying print setting data if any). As a result of the analysis, the data analyzer 110 determines print settings, for example, the size and orientation of paper to be used for printing, which of single-sided printing and double-sided printing is to be performed, and so forth, and reports the determined print settings to the engine controller 106. The data analyzer 110 according to the exemplary embodiment includes a separator detector 112 and a sort controller 114 in addition to the above-described typical function. The separator detector 112 detects a separator of each copy (and each job in some cases) from the print data. The sort controller 114 performs control that is necessary for sorting a printout in accordance with information representing the separator detected by the separator detector 112. The details of processes performed by the separator detector 112 and the sort controller 114 will be described below.

The drawing unit 104 interprets the print data and thereby generates print image data of individual pages. An analysis result obtained from the data analyzer 110 may be used to interpret the print data.

The engine controller 106 causes the print engine 120 to print the print image data generated by the drawing unit 104. Here, the engine controller 106 designates, with respect to the print engine 120, the paper feed tray to be used as a paper feeding source in accordance with the print settings determined by the data analyzer 110. The print engine 120 prints the image data received from the engine controller 106 on the paper fed from the paper feed tray designated by the engine controller 106.

The operation panel 108 is a user interface mechanism for local operations of the printer 10 and includes devices, such as a screen that displays information representing the operation status of the printer 10 and so forth, and a button and touch panel that receive input of instructions from a user.

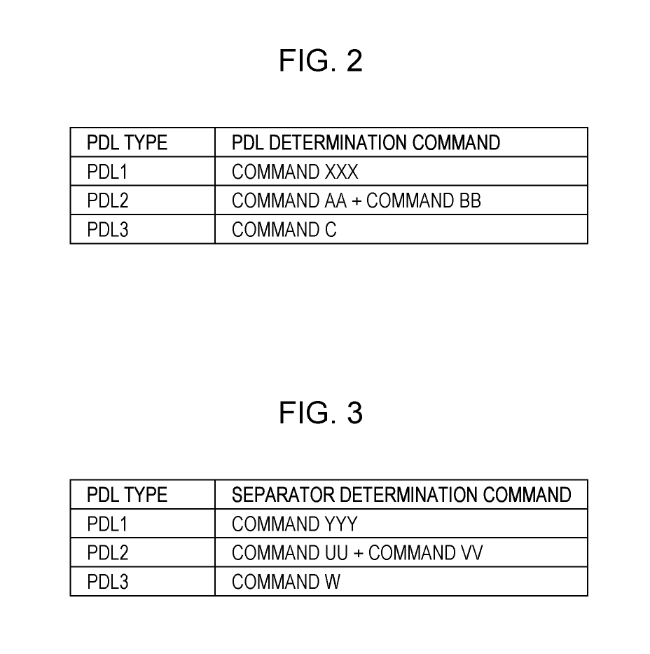

Next, determination criterion information for a separator between copies and so forth held by the data analyzer 110 will be illustrated. FIGS. 2 and 3 respectively illustrate examples of PDL determination information and separator determination information held by the data analyzer 110.

The PDL determination information illustrated in FIG. 2 represents, for each PDL type that is able to be handled by the printer 10, the name of the PDL type and the PDL determination command corresponding to the PDL type. The PDL determination command is a command that is included in the print data of the corresponding PDL type and that represents the PDL type. The PDL determination command is usually described at the top (or near the top) of the print data. The PDL determination command is not limited to a single command and may be a combination of plural commands. For example, in print data described in the PDL of the type “PDL2”, a combination of two commands “command AA” and “command BB” appears near the top of the print data.

The separator determination information illustrated in FIG. 3 represents, for each PDL type that is able to be handled by the printer 10, the name of the PDL type and the separator determination command corresponding to the PDL type. The separator determination command is a characteristic command that unexceptionally appears once in each copy of print data of the PDL type. The separator determination command is described near the top of the description of each copy of print data. The position where the separator determination command is described is after the above-described PDL determination command. A substantial print data portion defining the image content of each copy is described after the PDL determination command and the separator determination command. The separator determination command does not appear in the substantial print data portion. A command that satisfies such a condition may be searched for on the basis of the specifications of PDL or the like and the command may be used as a separator determination command. The separator determination command has an original purpose different from the purpose of indicating a separator between copies, and the printer driver of the client apparatus 20 inserts the command near the top of each copy of print data for that purpose. However, the command satisfies the above-described condition for indicating a separator and is thus also be used as a marker indicating a separator. At the top of a “copy” (or job), commands for setting parameters that have an influence on the entire copy (for example, color space, coordinate transformation matrix, and paper setting) are described. Some of these commands are not used for a portion describing the image content of each page to be printed according to the standard. A command to be used as a separator determination command may be selected from among these commands. As a separator determination command for a certain PDL type, a command that does not appear in print data of the other PDL types may be selected.

The separator determination command is not limited to a single command and may be a combination of plural commands. For example, in print data described in the PDL of the type “PDL2”, a combination of two commands “command UU” and “command VV” appears near the top of each copy, and thus the combination of the two commands is used as a separator determination command. In the case of using a combination of plural commands as a separator determination command, it is sufficient that the above-described condition, that is, the command appears only once in each copy of print data near the top of the description of the copy and does not appear in the substantial print data portion defining the image content, is satisfied by the overall combination of the commands, and the individual commands do not necessarily satisfy the condition.

The above-described PDL determination command may be used as a separator determination command. However, in some PDLs, a PDL determination command is not included in the description portion of each copy of print data, and thus a separator determination command is defined separately from a PDL determination command.

The PDL determination information and the separator determination information illustrated in FIGS. 2 and 3 may be created on the basis of information about various PDLs handled by the printer 10 and registered in the data analyzer 110 by the manufacturer of the printer 10.

The examples illustrated in FIGS. 2 and 3 are examples of a case where the printer 10 is compatible with plural PDLs. In a case where the printer 10 is compatible with only one PDL, the PDL determination information (FIG. 2) is not necessarily used, and a separator determination command corresponding to the one PDL may be registered as the separator determination information (FIG. 3).

Next, a process performed by the data analyzer 110 will be described.

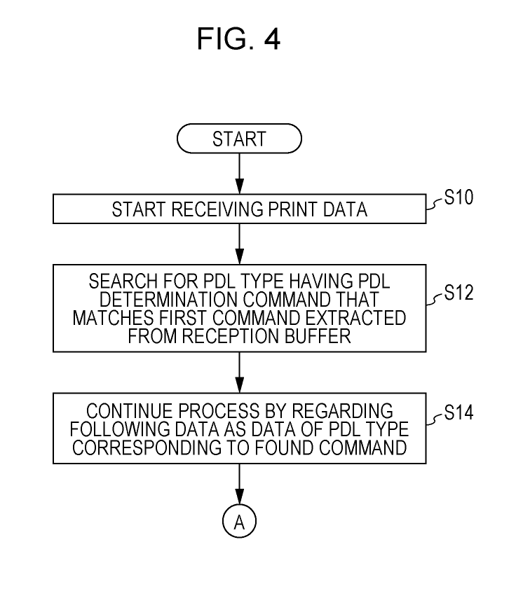

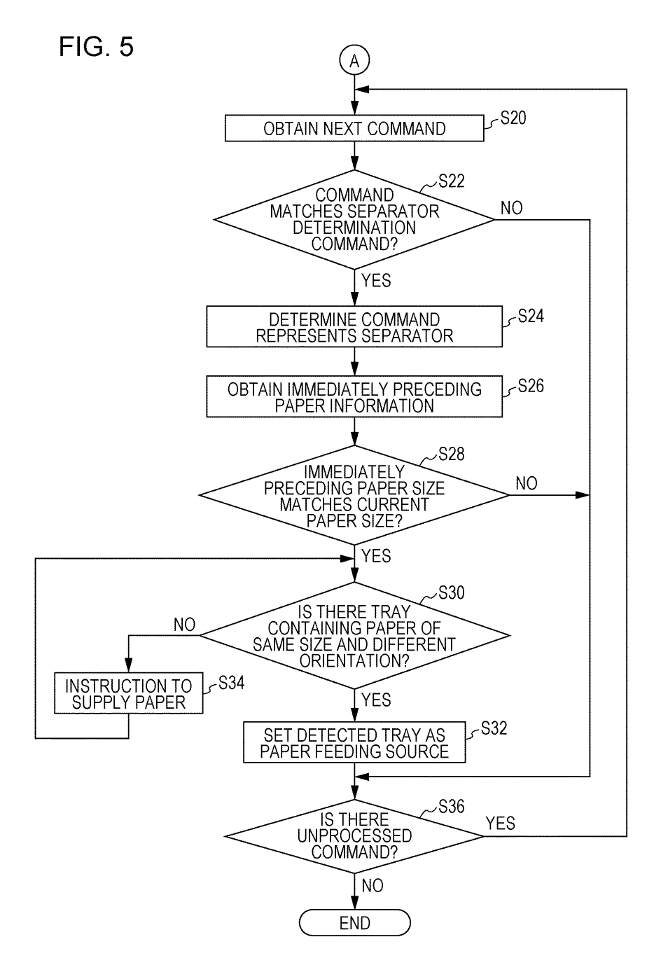

As illustrated in FIG. 4, the receiver 102 starts receiving print data 200 from the client apparatus 20 (S10). The client apparatus 20 starts sequentially transmitting the print data 200 from the top thereof, and the description of the print data 200 that is sequentially transmitted is held in a reception buffer included in the receiver 102. The data analyzer 110 extracts a first command from the reception buffer and searches for, among the PDL types included in the PDL determination information (FIG. 2), a PDL type having a PDL determination command that matches the extracted command (S12). If a PDL type having the matching PDL determination command is found, the data analyzer 110 determines that the PDL description that follows is of the PDL type corresponding to the matching PDL determination command. In this case, the data analyzer 110 sets the statuses of the individual units in the controller 100 (for example, the separator detector 112 and the drawing unit 104) so as to process the following PDL description by regarding it as a PDL description of the determined PDL type (S14). If the statuses already correspond to the PDL type, resetting is not necessary. For example, the data analyzer 110 reads the separator determination command corresponding to the determined PDL type from the separator determination information (FIG. 3) and sets the separator detector 112 so as to perform separator detection by using this separator determination command. If a PDL determination command that matches the command extracted first from the reception buffer is not found, the next command may be extracted from the reception buffer and a process similar to the above-described process may be repeated. In this way, after the PDL type of the data that is being processed has been determined and the controller 100 has become able to process the PDL of the type, the process proceeds to the process illustrated in FIG. 5.

In the process illustrated in FIG. 5, the separator detector 112 in the data analyzer 110 obtains the next command from the reception buffer in the receiver 102 (S20) and determines whether or not the obtained command matches the separator determination command corresponding to the PDL type determined in step S12 (S22). If the obtained command does not match the separator determination command, the process proceeds to step S36, where the sort controller 114 determines whether or not there is a command in the reception buffer in the receiver 102. If there is a command, the process returns to step S20.

On the other hand, if the determination result in step S22 is “YES” (match), the separator detector 112 determines that the command is a separator of each copy (S24).

Subsequently, the sort controller 114 obtains paper information (the size, orientation, and so forth of paper) at the time of the command immediately preceding that command (S26). The paper information is necessary to generate print image data and is available because it is managed by the drawing unit 104, for example. The obtained paper information is referred to as “immediately preceding” paper information. Subsequently, the sort controller 114 sequentially obtains, from the reception buffer, a group of commands following the command obtained in step S20, and obtains paper information from the obtained group of commands. The paper information obtained at this time represents the size and orientation of paper to be used in printing of the “copy” or “job” that comes after the separator determined in step S24. The paper information obtained at this time is referred to as “current” paper information. The sort controller 114 determines whether or not the paper size represented by the immediately preceding paper information matches the paper size represented by the current paper information (S28). If the sort controller 114 determines that both the paper sizes match, the sort controller 114 determines whether or not there is a paper feed tray that satisfies the condition “containing paper of the same size and different orientation relative to the size and orientation of paper represented by the immediately preceding paper information” (S30). For example, if the paper setting of the first copy that is being printed (or that has been printed) is A4 and SEF and if the paper setting of the second copy after the separator detected in steps S22 and S24 is A4 and SEF, a paper feed tray containing paper of A4 and LEF is searched for in step S30 (note that the orientation is different from the orientation originally designated in the print data). The size and orientation of the paper contained in individual paper feed trays of the print engine 120 may be determined with reference to the setting information managed by the controller 100.

If there is a paper feed tray that satisfies the condition in step S30 (the determination result in step S30 is YES), the sort controller 114 sets the paper feed tray as a tray serving as a paper feeding source for printing the data after the separator (S32). Also, at this time, the sort controller 114 performs control to make the coordinate system of drawing performed by the drawing unit 104 identical with the orientation of the paper on the tray that has been set as a paper feeding source. Specifically, if the orientation of the image represented by the print data is identical with the orientation of the paper on the tray that has been set as a paper feeding source, the sort controller 114 performs control so that the drawing unit 104 draws the print data after the separator as usual. Otherwise, the sort controller 114 performs control so that the drawing unit 104 draws the print data by rotating 90 or 270 degrees the coordinate system for drawing the print data in accordance with the orientation of the paper on the tray. According to steps S30 and S32, the orientation of the paper is changed 90 degrees (or 270 degrees) from LEF to SEF or from SEF to LEF at a detected separator, and the change in the orientation makes the copies before and after the separator sorted from each other.

After the orientation of the paper to be fed is changed in step S32, the sort controller 114 determines whether or not there is a command in the reception buffer of the receiver 102 (S36). If there is a command, the process returns to step S20, where the next command is obtained from the reception buffer and the process similar to that described above is repeated.

If the determination result in step S28 is “NO” (not match), the process proceeds to step S36, where the sort controller 114 determines whether or not there is a command in the reception buffer of the receiver 102. If there is a command, the process returns to step S20. In this case, the steps of changing the orientation of paper (S30 and S32) are skipped. If the paper size of the immediately preceding copy (or job) is different from the paper size of the current copy (or job), both copies are easily sorted from each other without changing the paper orientation, and thus the paper orientation is not changed.

If it is determined in step S30 that there is no paper feed tray satisfying the condition, the sort controller 114 suspends the printing process and displays, on the operation panel 108, an instruction to supply paper satisfying the condition in any of the paper feed trays (S34), and the process returns to step S30. If the user supplies the paper in response to the instruction, the determination result “YES” is obtained in step S30 and the process proceeds to step S32.

As described above, in the exemplary embodiment, with use of the existence of a characteristic command that appears in data of each copy only once among the commands usually inserted near the top of each copy of print data (before a substantial drawing command portion) by the printer driver of the client apparatus 20, such a command is used as a separator determination command. If the controller 100 finds the separator determination command in the print data, the controller 100 determines that the portion after the separator determination command is another “copy” different from the preceding one and changes the paper orientation between SEF and LEF for sorting the copies. In this method, the client apparatus 20 only has to convert document data to print data as usual and does not need to perform a special process of finding a separator position in the print data and inserting special separator information.

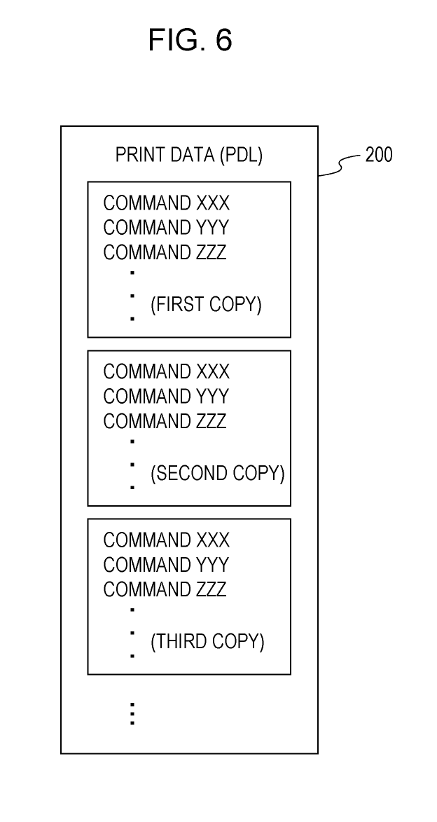

The flow of the above-described process will be described by using an example in which the print data 200 including descriptions of plural copies is input to the printer 10, which is schematically illustrated in FIG. 6. The description of a first copy included in the print data 200 illustrated in FIG. 6 includes “command XXX”, “command YYY”, and “command ZZZ” arranged in this order from the top, and thereafter a group of commands including drawing commands defining the image content of individual pages is arranged, although not illustrated. As in the first copy, the description of each of second and third copies includes “command XXX”, “command YYY”, and “command ZZZ” at the top thereof. The same applies to the fourth and subsequent copies. Furthermore, in this example, the information illustrated in FIGS. 2 and 3 is set as PDL determination information and separator determination information in the data analyzer 110.

If the print data 200 is transmitted in order from the first command, the data analyzer 110 recognizes, on the basis of “command XXX” at the top of the first copy, that the first copy is described in the PDL “PDL1”, determines that the separator command corresponding to “PDL1” is “command YYY”, and reports it to the separator detector 112. Since the next command is “command YYY”, the separator detector 112 recognizes that this command is a separator of the copy. At this time point, however, the first copy is being processed and there is no printed “copy” before, and thus the orientation of paper to be used for printing may be the one defined in the print data of the first copy. After that, the separator detector 112 examines the subsequent commands in the print data of the first copy. Any of these commands is not “command YYY” corresponding to the separator determination command. After that, the separator detector 112 detects that the second command in the second copy is “command YYY” corresponding to the separator determination command. Then the sort controller 114 selects the paper in the orientation different from that of the paper used to print the first copy (that is, the orientation orthogonal to the orientation of the first copy) as a paper feeding source and prints the second copy. The same applies to the third copy and the subsequent copies.

An exemplary embodiment of the present invention has been described above. The above-described embodiment is merely an example, and various modifications may be accepted within the scope defined by the attached claims.

For example, the printer 10 according to the exemplary embodiment uses a sorting method in which the paper orientation is changed for each copy, but the printer 10 may use another sorting method (for example, a method in which a paper output tray is shifted right and left).

The image content of each “copy” included in print data is not necessarily the same, and the image content of each copy may be partially different, for example, as in merge printing or variable printing.

In the foregoing exemplary embodiment, a description has been given of a separator detection method in the case of sorting print data transmitted as a single job from the client apparatus 20 by separating it into copies. This detection method may be used to detect a separator between jobs, as well as copies. That is, the separator determination command included in the top portion of the first copy of print data also indicates the top of the print data (job), and thus it is possible to detect a separator between jobs by using a method similar to the method according to the above-described exemplary embodiment. For example, in a case where plural jobs for printing data on paper of the same size and same orientation are continuously transmitted from one or plural client apparatuses 20 on a network to the printer 10 without pause, a separator of each job may be detected and the jobs may be sorted through the process according to the above-described exemplary embodiment.

The controller 100 illustrated above is implemented by causing a computer to execute a program representing the functions of the individual devices. Here, the computer has a circuit configuration as hardware in which a microprocessor such as a central processing unit (CPU), a memory (primary storage) such as a random access memory (RAM) and a read only memory (ROM), a controller that controls a fixed storage device such as a hard disk drive (HDD) or a solid state drive (SSD), various types of input/output (I/O) interfaces, and a network interface that performs control to establish a connection to a network such as a local area network (LAN) are connected to one another via a bus or the like. The bus may be connected to, via an I/O interface, for example, a disc drive for reading data from and/or writing data on a portable disc recording medium such as a CD or DVD, a memory reader/writer for reading data from and/or writing data on a portable nonvolatile recording medium of various standards such as a flash memory, and the like. The program describing the processes performed by the above-described functional modules is stored in a fixed storage device such as an HDD and is installed in the computer via a recording medium such as a CD or DVD or via a communication medium such as a network. The program stored in the fixed storage device is read into the RAM and is executed by the microprocessor such as a CPU, and thereby the above-described functional modules are implemented.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A printer comprising:
a receiver that receives print data described in a page description language;
a detector that detects a predetermined specific command from the print data received by the receiver, the print data corresponding to plural copies; and
a sort controller that, if the detector detects the specific command, performs control to sort a printout of a print data portion behind a copy of the plural copies having the detected specific command from a printout of a print data portion ahead of another copy of the plural copies having the detected specific command, wherein the plural copies are sorted without an expectation of a rotated output, thereby reducing a number of the plural copies that have the predetermined specific command.

2. The printer according to claim 1, further comprising:
a memory that stores, as the specific command, one command that is unexceptionally included in each copy of the print data for a purpose other than a purpose of indicating a separator of the copy,
wherein the detector detects the specific command stored in the memory from the print data.

3. The printer according to claim 1, further comprising:
a determiner that determines which page description language is used to describe the print data received by the receiver, wherein
the memory stores, for each of page description languages, the specific command corresponding to the page description language, and
the detector obtains, from the memory, the specific command corresponding to the page description language determined by the determiner and detects the obtained specific command from the print data.

4. A printing method comprising:
receiving print data described in a page description language;
detecting a predetermined specific command from the received print data, the print data corresponding to plural copies; and
if the specific command is detected, performing control to sort a printout of a print data portion behind a copy of the plural copies having the detected specific command from a printout of a print data portion ahead of another copy of the plural copies having the detected specific command, wherein the plural copies are sorted without an expectation of a rotated output, thereby reducing a number of the plural copies that have the predetermined specific command.

5. A non-transitory computer readable medium storing a program causing a computer to execute a process, the process comprising:
receiving print data described in a page description language;
detecting a predetermined specific command from the received print data, the print data corresponding to plural copies; and
if the specific command is detected, performing control to sort a printout of a print data portion behind a copy of the plural copies having the detected specific command from a printout of a print data portion ahead of another copy of the plural copies having the detected specific command, wherein the plural copies are sorted without an expectation of a rotated output, thereby reducing a number of the plural copies that have the predetermined specific command.
